(19) United States
(12) Patent Application Publication
(10) Pub. No.: US 2010/0188698 A1
(43) Pub. Date: Jul. 29, 2010

(54) METHOD FOR CONTROLLING IMAGE FORMING APPARATUS AND IMAGE FORMING SYSTEM

(75) Inventor: Shinji Koizumi, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/692,875

(22) Filed: Jan. 25, 2010

Related U.S. Application Data
(60) Provisional application No. 61/148,192, filed on Jan. 29, 2009.

(51) Int. Cl. G06F 3/12

(52) U.S. Cl. 358/1.15; 358/1.16

(57) ABSTRACT

There is provided an image forming system includes a terminal device and an image forming apparatus. The terminal device comprises a selection display unit that displays a selection message to select whether or not to immediately execute private printing which is executed if an operation unit of the image forming apparatus is operated, and a command transmitting unit that transmits a sleep return command to the image forming apparatus to wake up the image forming apparatus from a sleep state if the private printing is selected to be executed immediately. The image forming apparatus comprises a command receiving unit that receives the sleep return command from the terminal device, and a return processing unit that executes sleep return processing to achieving a state where image formation is possible if the command receiving unit receives the sleep return command.

### CROSS-REFERENCE TO RELATED APPLICATION

This application claims the benefit of U.S. Provisional Application No. 61/148,192, filed Jan. 29, 2009.

### TECHNICAL FIELD

The invention relates to a method for controlling image forming apparatuses such as digital multifunction peripherals that print image data transmitted from terminal devices that users operate and an image forming system having terminal devices and an image forming apparatus.

### BACKGROUND

Conventionally, image forming apparatuses such as digital multifunction peripherals have a function of communicating with user terminals such as personal computers. An image forming apparatus having such a function of communicating with terminal devices implements a network print function that executes a printing process requested from a user terminal. The network print function includes a printing function called private printing, which is a function for increasing the security level of a printing result. The private printing is a function that causes an image forming apparatus to hold print data transmitted thereto from a user terminal so that printing is executed if the user directly operates the image forming apparatus at any time. If the private printing is used, since the user enters a print execution instruction in a state of directly contacting an operation unit of the image forming apparatus, the user is near the image forming apparatus if the image forming apparatus is executing printing. As a result, with the private printing, the user is able to perceive the output of the printing result or immediately retrieve the printing result. For this reason, the private printing enables reducing the risk of the printing result being seen or picked up by other persons, thus achieving a printing process with a high security level.

On the other hand, the image forming apparatus such as a digital multifunction peripheral has a sleep mode (also referred to as a power consumption reduction mode or a power saving mode) for reducing standby power consumption. In the image forming apparatus such as a digital multifunction peripheral, sleep return processing such as warm-up needs to be performed so as to transition from a sleep mode state (sleep state) to a ready state where the execution of printing is possible. For example, in an electrophotographic image forming apparatus, warm-up processing for heating a fixing unit to an appropriate temperature is necessary. That is to say, an image forming apparatus in the sleep mode takes time for processing (sleep return processing) such as warm-up for transition to a ready state before printing is actually started.

In the conventional private printing, a user sends an image (document) to be printed to an image forming apparatus as print data from a terminal device that the user operates and then moves to the image forming apparatus to input a print execution instruction on the operation unit of the image forming apparatus. For this reason, if the image forming apparatus is in the sleep mode, the user who directly operates the operation unit of the image forming apparatus to input the print execution instruction has to wait near the image forming apparatus for the time needed for completing the sleep return processing such as warm-up before printing is actually started.

Therefore, for example, if the sleep return processing is started upon receipt of print data for private print jobs similar to a normal printing process, there is a possibility that the image forming apparatus may consume unnecessary power until an actual print execution instruction is input from the user. This is because not all of the users who enter private print jobs to the user terminals immediately can be said to operate the image forming apparatus to start execution of printing. That is to say, if the sleep return processing is started at the receipt time of the print data for all of the private print jobs, the image forming apparatus may consume more unnecessary power.

### SUMMARY

An aspect of the invention provides a method for controlling an image forming apparatus at a terminal device which comprises: displaying a selection message to select whether or not to immediately execute private printing which is executed if an operation unit of the image forming apparatus is operated; and transmitting a sleep return command to the image forming apparatus to wake up the image forming apparatus from a sleep state if the private printing is selected to be executed immediately.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically illustrating an exemplary configuration of an image forming system.

FIG. 2 is a block diagram illustrating an exemplary configuration of the control system of a digital multifunction peripheral and a user terminal.

FIG. 3 is a flowchart illustrating the operation of the user terminal according to a first processing example of private printing.

FIG. 4 is a diagram illustrating an example of a selection window which is displayed on a display unit of the user terminal so as to enable a user to select the time to start printing.

FIG. 5 is a diagram illustrating an example of a guide message indicating that a digital multifunction peripheral is under sleep return processing.

FIG. 6 is a diagram illustrating an example of a guide message indicating that the digital multifunction peripheral is now in a ready state where printing is possible.

FIG. 7 is a flowchart illustrating the operation of the digital multifunction peripheral according to the first processing example of private printing.

FIG. 8 is a flowchart illustrating the operation of the digital multifunction peripheral according to the first and third processing examples of the private printing.

FIG. 9 is a flowchart illustrating the operation of the user terminal according to a second processing example of the private printing.

FIG. 10 is a flowchart illustrating the operation of the digital multifunction peripheral according to the second processing example of the private printing.

FIG. 11 is a flowchart illustrating the operation of the digital multifunction peripheral according to the second processing example of the private printing.

FIG. 12 is a flowchart illustrating the operation of the digital multifunction peripheral according to the second processing example of the private printing.

FIG. 13 is a flowchart illustrating the operation of the user terminal according to the third processing example of the private printing.

FIG. 14 is a diagram illustrating an example of a guide message that gives information on the time remaining to complete sleep return processing.

FIG. 15 is a flowchart illustrating the operation of the digital multifunction peripheral according to the third processing example of the private printing.

### DETAILED DESCRIPTION

Hereinafter, the embodiments of this invention will be described with reference to the drawings.

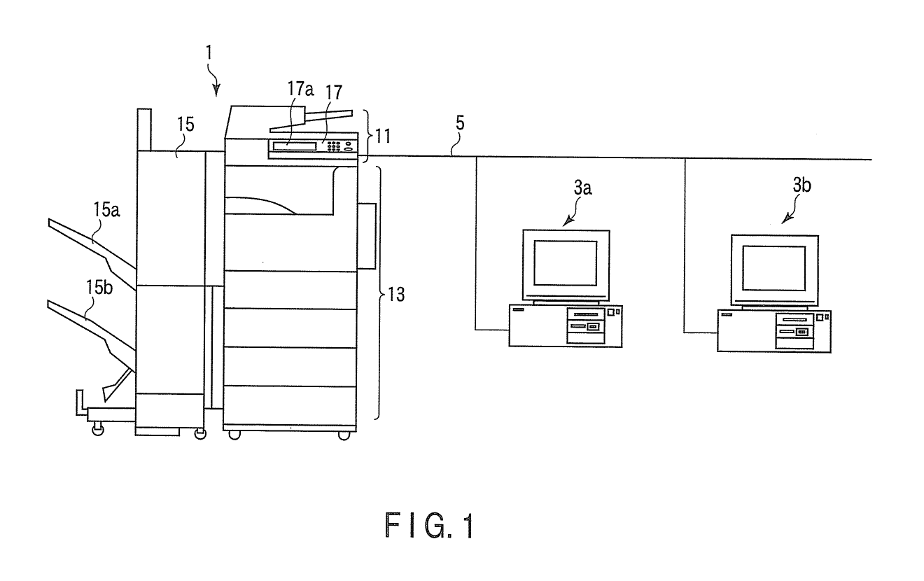

FIG. 1 is a diagram schematically illustrating an exemplary configuration of an image forming system.

As illustrated in FIG. 1, the image forming system includes a digital multifunction peripheral 1, a plurality of user terminals 3 (3a, 3b, and so on), and a local area network (LAN) 5.

The digital multifunction peripheral (MFP) 1 functions as an image forming apparatus (printing apparatus). The digital multifunction peripheral 1 has a scanner function, a printer function, a network communication function, and other functions. The digital multifunction peripheral 1 also has a network print function that executes a printing process requested from the user terminal 3.

The user terminal 3 (3a, 3b, or the like) is a terminal device used by each user. The user terminal 3 has a communication function of performing data communication with the digital multifunction peripheral 1 via the LAN 5. The user terminal 3 may be a device that is capable of communicating with the digital multifunction peripheral 1. The user terminal 3 is configured by a personal computer, for example. Moreover, the user terminal 3 may be a portable terminal device that is capable of communicating with the digital multifunction peripheral 1 by radio communication or the like.

The user terminal 3 is capable of having a plurality of applications (utilities) installed therein. The user terminal 3 implements various processing functions with the aid of the installed applications (utilities). For example, the user terminal 3 has installed therein a printer driver that transmits a print request to the digital multifunction peripheral 1. The printer driver enables the user terminal 3 to implement a function of transmitting a print request to the digital multifunction peripheral 1 and receiving print settings being requested.

Next, a configuration of the digital multifunction peripheral 1 will be described briefly.

As illustrated in FIG. 1, the digital multifunction peripheral 1 includes a scanner (image reading unit) 11, a printer (image forming unit) 13, a finisher 15, and an operation panel 17. In addition, the digital multifunction peripheral 1 includes various external interfaces that input or output image data thereto or therefrom. For example, the digital multifunction peripheral 1 has a FAX interface for sending and receiving FAX data, a network interface for achieving network communication, and other interfaces. With such a configuration, the digital multifunction peripheral 1 is able to function as a copier, a scanner, a printer, a FAX machine, and a network communicator.

The scanner 11 is a unit that reads images on either surface of an original document to obtain color image data (multi-value image data) or monochrome image data. The scanner 11 optically scans either surface of an original document to read images on either surface of the original document. The scanner 11 includes a scanning mechanism, a photoelectric conversion unit, a document feeding unit (ADF), and the like.

The printer 13 is a unit that forms an image based on color image data (multi-value image data) or monochrome image data on a paper. For example, the printer 13 is an electrophotographic image forming apparatus that has a paper receiving portion, a paper transportation mechanism, an exposure unit, a photoconductive drum, a developing unit, a transfer belt, a transfer unit, a fixing unit, and the like. The printer 13 is not limited to an electrophotographic printer but may be one that forms images by other printing methods such as an ink jet method or a heat-transfer method.

In the printer 13, the paper transportation mechanism transports paper that is set on the paper receiving portion. The exposure unit forms latent images on the photoconductive drum. The developing unit develops the latent images on the photoconductive drum with toner (in the case of color printing, toner of each color). The transfer unit transfers toner images on the photoconductive drum developed by the developing unit to paper with the aid of the transfer belt. The fixing unit fixes the toner images onto the paper, for example, by heating the paper in a pressurized state. The paper transportation mechanism outputs the paper having the toner images fixed thereto to the finisher 15 as a printing result.

Moreover, the printer 13 includes sensors (not shown) for detecting various statuses. For example, the printer 13 includes a sensor for detecting a residual toner amount, a sensor for detecting the presence of paper in the paper receiving portion, a sensor for detecting a transportation state (e.g., a paper jam) of the paper by the paper transportation mechanism. Each sensor installed in the printer 13 sends a detection signal to a system control unit 20 described later.

The operation panel 17 is a user interface. The operation panel 17 includes various operation keys and a display device (display unit) 17a having a built-in touch panel, for example. The operation panel 17 functions as an operation unit that users operate to input an operation instruction and a display unit that displays messages to users. For example, with the operation panel 17, users are able to input a print execution instruction for private printing. Moreover, with the operation panel 17, users are able to input authentication information for user authentication.

Next, a configuration of the control system of the digital multifunction peripheral 1 and the user terminal 3 will be described.

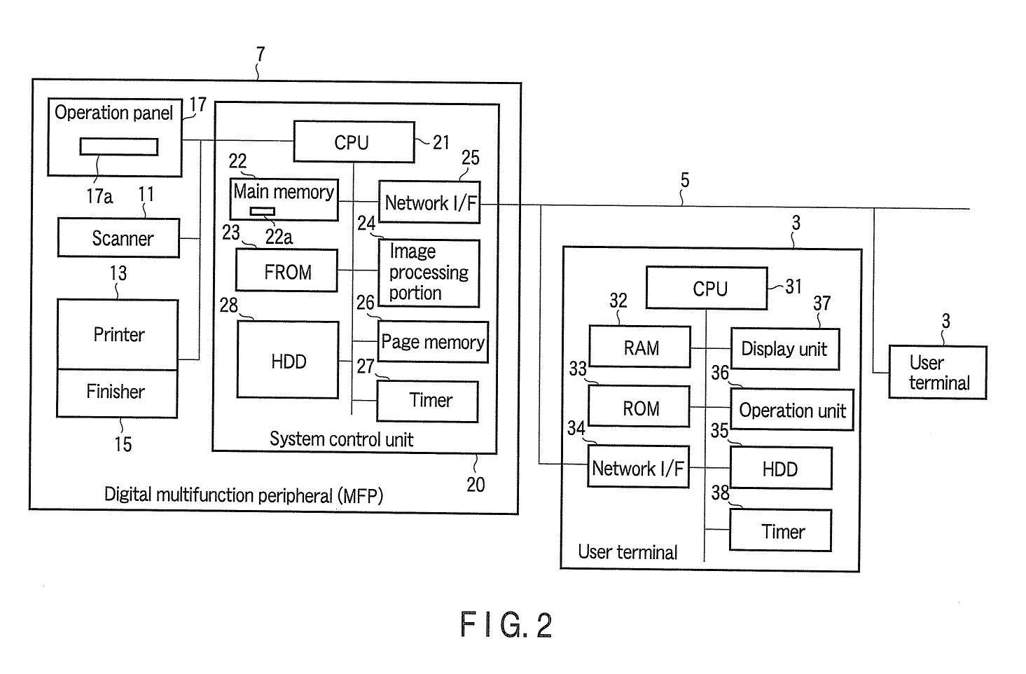

FIG. 2 is a block diagram illustrating an exemplary configuration of the control system of the digital multifunction peripheral 1 and the user terminal 3.

As illustrated in FIG. 2, the digital multifunction peripheral 1 includes a system control unit 20 that controls the overall operation of each unit. For example, the system control unit 20 controls the scanner 11 and the printer 13. The system control unit 20 acquires user instructions from the operation panel 17. The system control unit 20 includes a CPU 21, a main memory 22, a flash ROM (FROM) 23, an image processing portion 24, a network interface 25, a page memory 26, a timer 27, an HDD 28, and the like.

The CPU 21 is a processor that performs arithmetic processing. The CPU 21 implements various processing functions by executing control programs stored in the FROM 23 or HDD 28. The main memory 22 is configured by a random-access memory (RAM) or the like. The main memory 22 functions as a working memory. Moreover, the main memory 22 stores flags indicating operation statuses of each unit. The main memory 22 includes a table 22a for managing printing processes as print jobs. The table 22a stores management information for controlling jobs such as print jobs.

The FROM 23 is configured as a rewritable nonvolatile memory. The FROM 23 stores control programs, control data, and the like necessary for the operation of the digital multifunction peripheral 1. Moreover, control data, setting information, or the like are written to the FROM 23. The image processing portion 24 processes the image data read by the scanner 11 or image data received from the user terminal 3 via a network. For example, the image processing portion 24 has a RIP function that generates image data by rasterizing a page description language that is received from the user terminal 3 via the LAN 5. The RIP function may be implemented by the CPU 21 executing programs stored in the FROM 23 with the aid of the main memory 22.

The network interface 25 is a LAN interface that establishes communication with an external device via the LAN 5. The page memory 26 is a memory for expanding image data for printing. The page memory 26 has a capacity capable of expanding image data for at least one page. The timer 27 counts the time elapsed. The HDD 28 is a large-capacity memory for data storage. The HDD 28 stores image data to be printed, for example.

Next, the configuration of the user terminal 3 will be described.

The user terminal 3 is a terminal device that has a function of communication with the digital multifunction peripheral 1 and implements various processing functions by executing various applications (utilities). In the exemplary configuration shown in FIG. 2, the user terminal 3 is assumed as having a configuration similar to a typical personal computer (PC). The user terminal 3 shown in FIG. 2 includes a CPU 31, a RAM 32, a ROM 33, a network interface (I/F) 34, an HDD 35, an operation unit 36, a display unit 37, and a timer 38.

The CPU 31 controls the overall operation of the user terminal 3. The CPU 31 implements various processing functions by executing programs (applications or utilities) stored in the ROM 33 or HDD 35. The RAM 32 is a working memory. The ROM 33 stores control programs, control data, and the like necessary for the basic operation of the user terminal 3. The HDD 35 is a storage device for data storage. The HDD 35 may have applications (utilities) installed therein. For example, a printer driver and various applications (utilities) for controlling the digital multifunction peripheral 1 may be installed in the HDD 35.

The operation unit 36 is configured, for example, by a keyboard, a pointing device, and the like for enabling users to input operation instructions. The display unit 37 is configured by a liquid-crystal display, and the like. The network interface 34 is a LAN interface that establishes data communication with each unit existing in the LAN 5. For example, the user terminal 3 is able to transmit and receive data to and from the digital multifunction peripheral 1 via the LAN 5 with the aid of the network interface 34. The timer 38 counts the time elapsed.

Next, the management of network printing in the digital multifunction peripheral 1 will be described.

In network printing, the system control unit 20 of the digital multifunction peripheral 1 stores print data received from the user terminal 3 in the HDD 28 and manages printing of the print data. The system control unit 20 of the digital multifunction peripheral 1 manages each printing process of the print data stored in the HDD 28 as one job. The printing processes managed as jobs include a printing process which is called private printing that executes actual printing on condition that a user directly operates the operation unit 17 of the digital multifunction peripheral 1.

For private printing to be executed, the user has to be near the digital multifunction peripheral 1. That is to say, the digital multifunction peripheral 1 manages private printing as a private print job and holds the print data for that private print job in a storage device such as the HDD 28 until the user directly operates the operation unit 17. If executing private print jobs, the digital multifunction peripheral 1 may perform user authentication for user identification. If performing user authentication, the digital multifunction peripheral 1 may execute the private print jobs only if a user having succeeded in the user authentication inputs a print execution instruction on the operation panel 17.

Next, a first processing example of private printing in the image forming system will be described.

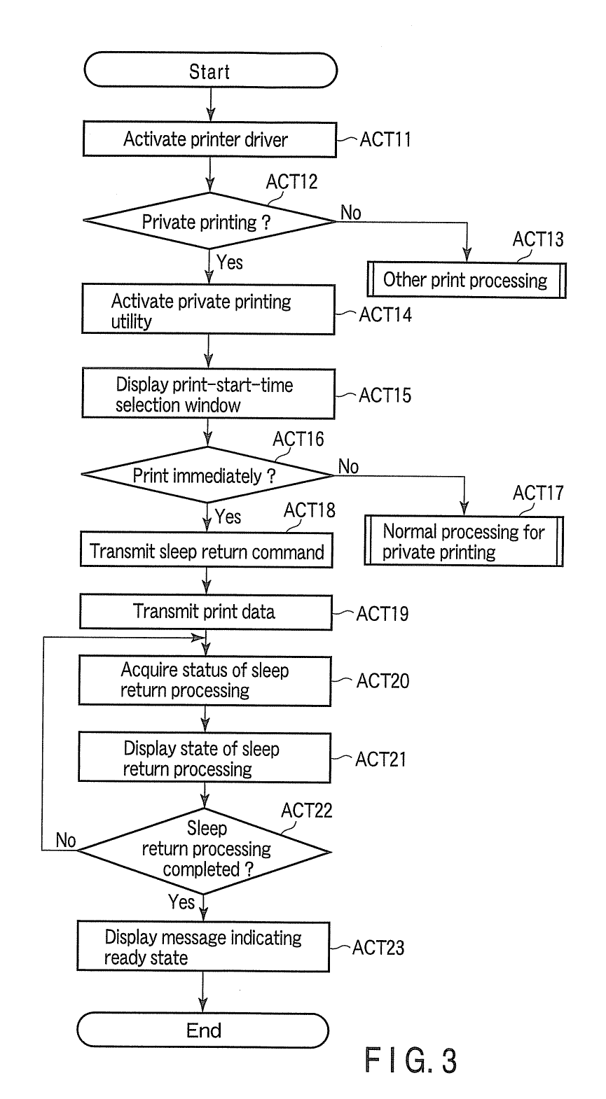

FIG. 3 is a flowchart illustrating an exemplary operation of the user terminal 3 according to the first processing example of private printing.

If a user of the user terminal 3 wants to print an image such as a document being displayed, the user issues a print instruction for that image by operating the operation unit 36. For example, the user issues a print instruction by pressing a print button that is provided by an application for opening an image such as a document to be printed. Upon receiving the print instruction, the CPU 31 of the user terminal 3 activates a printer driver that is installed in the HDD 35 (ACT 11).

The printer driver is a software for sending a print request to the digital multifunction peripheral 1. If a plurality of printer drivers is installed in the user terminal 3, the CPU 31 of the user terminal 3 may activate a printer driver selected by the user. If a printer driver for the digital multifunction peripheral 1 is activated, the CPU 31 of the user terminal 3 displays a print setting screen including settings of private printing on the display unit 37. In the print setting screen, the user is able to select whether or not to select private printing (ACT 12).

If private printing is not selected in the print setting screen (ACT 12: NO), the CPU 31 of the user terminal 3 sends a normal print request other than a private print request to the digital multifunction peripheral 1 (ACT 13). Here, normal printing is a printing process in which the user terminal 3 transmits print data to the digital multifunction peripheral 1, and the digital multifunction peripheral 1 prints the print data received from the user terminal 3 at any time (e.g., in the receipt order). In the normal printing, the digital multifunction peripheral 1 immediately executes sleep return processing if the digital multifunction peripheral 1 is in the sleep state at the time of receiving the print data from the user terminal 3. Upon waking up from the sleep state, the digital multifunction peripheral 1 immediately starts printing the received print data. That is to say, in the normal printing, the printing results of the received print data are sequentially output to a paper discharge portion regardless of the user's location. A user who issued a print instruction for normal printing goes to the digital multifunction peripheral 1 at any time to retrieve the printing result discharged to the paper discharge portion.

If private printing is selected in the print setting screen (ACT 12: YES), the CPU 31 of the user terminal 3 activates a utility software for private printing (ACT 14). If the private printing utility is activated, the CPU 31 displays a selection window (print-start-time selection window) as a pop-up window on the display unit 37 so as to enable the user to select the time to start actual printing (whether or not to immediately start printing) (ACT 15).

The private printing utility may be configured such that it is activated only if the digital multifunction peripheral 1 is in the sleep state but is not activated if the digital multifunction peripheral 1 is not in the sleep state. For example, the CPU 31 of the user terminal 3 is able to determine whether or not the digital multifunction peripheral 1 is in the sleep state by making inquiries to the digital multifunction peripheral 1 as to whether or not it is in the sleep state if the private printing is selected in the print setting screen. Based on the determination result, the CPU 31 of the user terminal 3 is able to determine whether or not to activate the private printing utility.

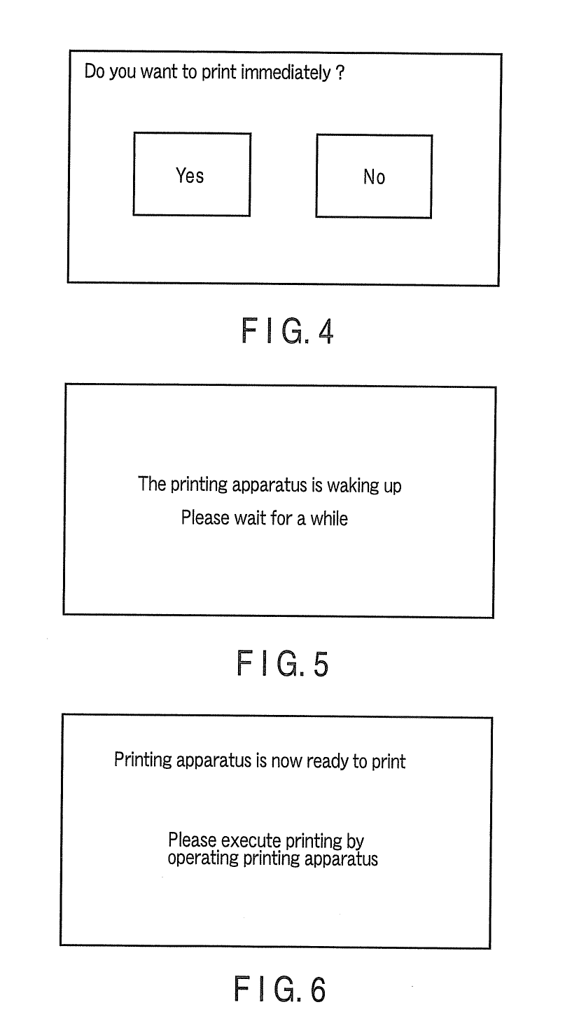

FIG. 4 illustrates an example of a selection window displayed on the display unit 37 so as to enable a user to select the time to start printing.

In the example shown in FIG. 4, the display unit 37 displays icons “YES” and “NO” together with a message “Do you want to print immediately?”. The “YES” icon is a key that the user presses to select an option to execute private printing immediately. The “NO” icon is a key that the user presses to select an option not to execute private printing immediately. The “YES” and “NO” icons are selected by the user with the aid of the operation unit 36 such as a pointing device.

In the selection window shown in FIG. 4, if the user does not want to execute private printing immediately, the user selects the “NO” icon. If the user selects the option not to execute private printing immediately, namely, if the user selects the “NO” icon, the user terminal 3 transmits print data for private printing to the digital multifunction peripheral 1 without outputting a sleep return request.

That is to say, if the user selects the option not to execute private printing immediately (ACT 16: NO), the CPU 31 of the user terminal 3 performs a normal operation of outputting a request for normal private printing to the digital multifunction peripheral 1 without outputting a sleep return request (ACT 17). In the normal private printing, the CPU 31 of the user terminal 3 transmits print data for private printing to the digital multifunction peripheral 1 without transmitting a sleep return command. In the normal private printing, the digital multifunction peripheral 1 does not perform sleep return processing such as warm-up immediately even if it is in the sleep state, but holds the print data from the user terminal 3 as print data for private printing. In this case, the digital multifunction peripheral 1 executes the sleep return processing in response to the user instruction made on the operation panel 17, and then executes the private printing.

In the selection window shown in FIG. 4, the user who wants to execute private printing immediately selects the “YES” icon. If the user selects the option to execute private printing immediately, namely, if the user selects the “YES” icon, the CPU 31 of the user terminal 3 issues a sleep return request to the digital multifunction peripheral 1 by outputting a sleep return command to the digital multifunction peripheral 1.

That is to say, if the user selects the option to execute private printing immediately (ACT 16: YES), the CPU 31 of the user terminal 3 transmits a sleep return command to the digital multifunction peripheral 1 via the LAN 5 with the aid of the network interface 34, requesting the digital multifunction peripheral 1 to wake up from the sleep state (ACT 18), and transmits print data for private printing (ACT 19).

The user terminal 3 having transmitted the sleep return command and the print data receives the status indicating the state of sleep return processing from the digital multifunction peripheral 1 with the aid of the network interface 34 (ACT 20). Upon receiving the status indicating the state of sleep return processing from the digital multifunction peripheral 1, the CPU 31 of the user terminal 3 displays a guide message that gives information on the state of sleep return processing in the digital multifunction peripheral 1 on the display unit 37 based on the received status indicating the state of sleep return processing (ACT 21).

For example, upon receiving the status indicating that sleep return processing is started, the CPU 31 of the user terminal 3 displays a guide message indicating that the digital multifunction peripheral 1 has started the sleep return processing on the display unit 37. Moreover, upon receiving the status indicating that the sleep return processing is being executed, the CPU 31 of the user terminal 3 displays a guide message indicating that the digital multifunction peripheral 1 is under the sleep return processing on the display unit 37.

FIG. 5 illustrates an example of a guide message indicating that the digital multifunction peripheral 1 is under sleep return processing.

In the example shown in FIG. 5, the display unit 37 displays messages “The printing apparatus is waking up” and “Please wait for a while”. The CPU 31 of the user terminal 3 may display such a guide message as shown in FIG. 5 on the display unit 37 upon receiving a notification of start of sleep return processing from the digital multifunction peripheral 1 before a notification of completion of the sleep return processing is received. Moreover, the CPU 31 of the user terminal 3 may display the guide message shown in FIG. 5 on the display unit 37 as a pop-up window.

The control of displays based on the status indicating the state of sleep return processing acquired from the digital multifunction peripheral 1 is implemented by the CPU 31 executing an application (utility). For this reason, by updating the application, the contents displayed on the display unit 37 can be configured easily.

Upon receiving the status indicating the completion of sleep return processing from the digital multifunction peripheral 1, the CPU 31 of the user terminal 3 determines that the sleep return processing in the digital multifunction peripheral 1 is completed (ACT 22: YES). If the sleep return processing in the digital multifunction peripheral 1 is determined to be completed (ACT 22: YES), the CPU 31 of the user terminal 3 displays a guide message on the display unit 37, indicating that the digital multifunction peripheral 1 is now in a ready state where private printing is executable immediately (ACT 23).

FIG. 6 illustrates an example of a guide message indicating that the digital multifunction peripheral 1 is now in a ready state where printing is possible.

In the example shown in FIG. 6, the display unit 37 displays messages “Printing apparatus is now ready to print” and “Please execute printing by operating printing apparatus”. For example, upon receiving a notification of completion of sleep return processing, the CPU 31 of the user terminal 3 displays such a guide message as shown in FIG. 6 on the display unit 37. The CPU 31 of the user terminal 3 may display the guide message shown in FIG. 6 on the display unit 37 as a pop-up window.

The control of displays for the guide message indicating the completion of sleep return processing (the completion of print preparation) acquired from the digital multifunction peripheral 1 is implemented by the CPU 31 executing an application (utility). For this reason, by updating the application, the contents displayed on the display unit 37 as the message indicating the completion of print preparation can be configured easily.

If the guide message indicating the completion of sleep return processing as shown in FIG. 6 is displayed on the display unit 37, the user moves to an installation site of the digital multifunction peripheral 1. At that time, the digital multifunction peripheral 1 has completed the sleep return processing. For this reason, if the user who has moved to the front of the digital multifunction peripheral 1 inputs a print execution instruction into the operation panel 17, the printer 13 of the digital multifunction peripheral 1 executes printing immediately. As a result, the user is able to retrieve the printing results immediately without having to wait for completion of sleep return processing in the digital multifunction peripheral 1.

Next, the operation of the digital multifunction peripheral 1 according to the first processing example of the private printing will be described.

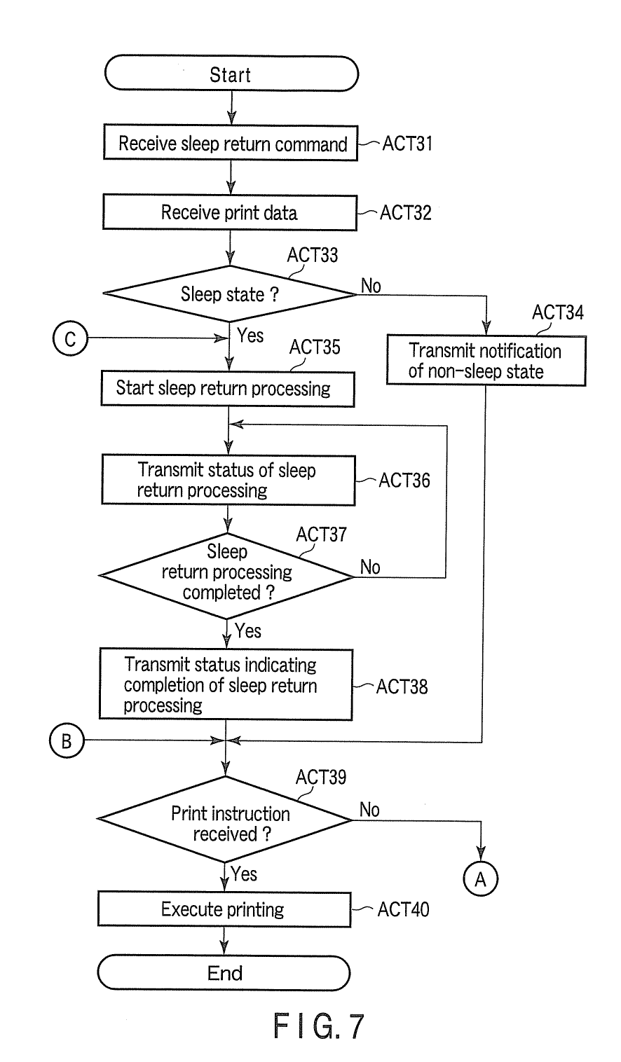

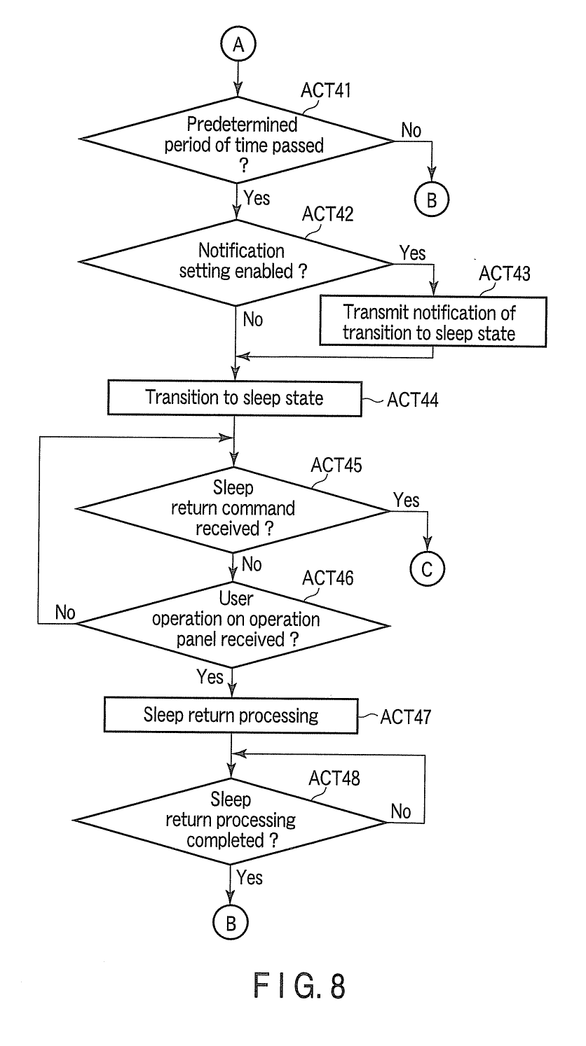

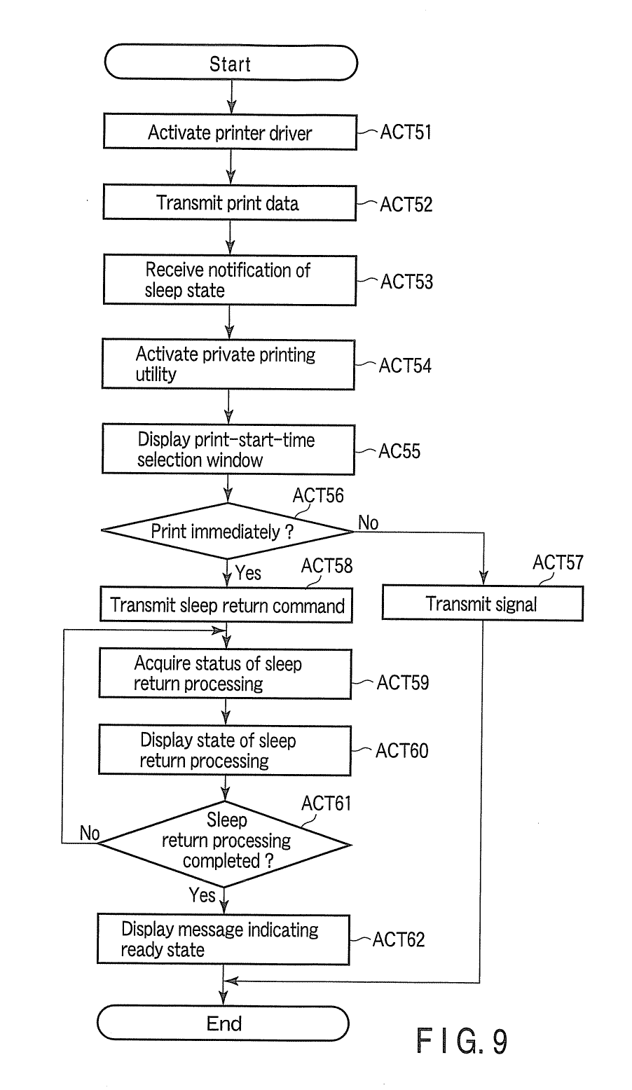

FIGS. 7 and 8 are flowcharts illustrating the operation of the digital multifunction peripheral 1 according to the first processing example of the private printing.

First, the digital multifunction peripheral 1 receives a sleep return command from the user terminal 3 with the aid of the network interface 25 (ACT 31) and receives print data for private printing (ACT 32). The CPU 21 of the digital multifunction peripheral 1 stores the print data for private printing received by the network interface 25 in the HDD 28. The CPU 21 of the digital multifunction peripheral 1 manages the print data stored in the HDD 28 as print data for private printing. For example, the CPU 21 manages the print data stored in the HDD 28 as private print jobs correlated with user information.

Upon receiving the sleep return command together with the print data from the user terminal 3, the CPU 21 of the digital multifunction peripheral 1 determines whether or not the digital multifunction peripheral 1 is in the sleep state (ACT 33). If the digital multifunction peripheral 1 is not in the sleep state (ACT 33: NO), the CPU 21 sends a notification to the user terminal 3, informing that the digital multifunction peripheral 1 is not in the sleep state (alternatively, the digital multifunction peripheral 1 is in a ready state where printing is possible) (ACT 34). If the digital multifunction peripheral 1 is in the sleep state (ACT 33: YES), the CPU 21 starts sleep return processing such as warm-up in the printer 13 (ACT 35).

If the sleep return processing is started in response to the sleep return command, the CPU 21 of the digital multifunction peripheral 1 transmits the status indicating the state of sleep return processing to the user terminal 3 (ACT 36). The status indicating the state of the sleep return processing may have various forms in terms of the contents indicated by the status and the transmission time of the status. The status indicating the state of the sleep return processing is intended at least to notify the user terminal 3 of the facts that the digital multifunction peripheral 1 is under the sleep return processing, and that the digital multifunction peripheral 1 has completed the sleep return processing (namely, the digital multifunction peripheral 1 is in the ready state where printing is possible).

For example, the CPU 21 of the digital multifunction peripheral 1 periodically transmits the status indicating the state of the sleep return processing to the user terminal 3 during the execution of the sleep return processing. Moreover, the CPU 21 of the digital multifunction peripheral 1 may transmit the time of start and completion of the sleep return processing to the user terminal 3 as the status indicating the execution state of the sleep return processing. Furthermore, the CPU 21 of the digital multifunction peripheral 1 may calculate the time remaining to complete the sleep return processing and transmits the calculated time to the user terminal 3 as the status indicating the execution state of the sleep return processing.

Upon completion of the sleep return processing (ACT 37: YES), the CPU 21 of the digital multifunction peripheral 1 notifies the user terminal 3 of the status indicating the completion of the sleep return processing (ACT 38). If the sleep return processing is completed, the digital multifunction peripheral 1 is in a ready state where printing is executable immediately. The digital multifunction peripheral 1 being in the ready state where printing is executable immediately waits until the user inputs a print execution instruction of the private printing on the operation panel 17 (ACT 39).

If the user inputs a print execution instruction for the private printing on the operation panel 17 (ACT 39: YES), the CPU 21 of the digital multifunction peripheral 1 reads print data for that private printing from the HDD 38 and executes printing with the printer 13 (ACT 40).

In the state of waiting for a print execution instruction, the CPU 21 determines whether or not the time elapsed from the sleep return exceeds a predetermined period of time, after the lapse of which the sleep state starts again (ACT 41). If the time elapsed from the sleep return exceeds the predetermined period of time (ACT 41: YES), the CPU 21 determines whether or not a setting to send a notification if the digital multifunction peripheral 1 transitions to the sleep state again is enabled (ACT 42). It will be assumed that in the digital multifunction peripheral 1, it is possible to make settings as to whether or not to send a notification if the digital multifunction peripheral 1 transitions to the sleep state again after waking up from the sleep state in response to the sleep return command.

For example, the digital multifunction peripheral 1 is configured to transition to the sleep state if a non-operation state continues for a predetermined period of time or more. For this reason, if the user does not input any instruction to the operation panel 17 of the digital multifunction peripheral 1 for a while after sending the sleep return command from the user terminal 3, the digital multifunction peripheral 1 transitions to the sleep state. In such a case, with the digital multifunction peripheral 1, it is possible to make settings as to whether or not to send a notification if the digital multifunction peripheral 1 transitions to the sleep state again after waking up from the sleep state in response to the sleep return command.

If there is the setting to send a notification if the digital multifunction peripheral 1 transitions to the sleep state again after waking up in response to the sleep return command (ACT 42: YES), the CPU 21 sends a notification to the user terminal 3 to inform that the sleep state starts again (ACT 43) and causes the digital multifunction peripheral 1 to transition to the sleep state (ACT 44).

Upon receiving the notification that the sleep state starts again, the user terminal 3 displays a message that the sleep state is started again and displays a sleep return command using the private printing utility. However, if the notification that the sleep state starts again is received, the user terminal 3 may display the message that the sleep state is started again but may not display the sleep return command using the private printing utility.

If the setting to send a notification of the transition to another sleep state is not enabled (ACT 42: NO), the CPU 21 causes the digital multifunction peripheral 1 to transition to the sleep state (ACT 44) without sending a notification to the user terminal 3 to inform that the sleep state starts again. If the sleep state starts again in ACT 44, the CPU 21 enables reception of a sleep return command from the user terminal 3 (ACT 45).

Upon receiving the sleep return command from the user terminal 3 after the sleep state is started again (ACT 45: YES), the CPU 21 proceeds to ACT 36 and starts the sleep return processing to execute the operations starting from ACT 36 again.

Moreover, if the user inputs an instruction to the operation panel 17 to perform sleep return processing (ACT 46: YES) after the sleep state is started again before the sleep return command is received (ACT 45: NO), the CPU 21 executes the sleep return processing (ACT 47). If the sleep return processing is executed in response to an operation on the operation panel 17, the CPU 21 may not transmit the status indicating the state of the sleep return processing to the user terminal 3. If the sleep return processing is completed (ACT 48: YES), the CPU 21 enters a standby state of waiting for a print execution instruction (ACT 39).

Next, a second processing example of private printing in the image forming system will be described.

In the first processing example, if the private printing is selected, the private printing utility is activated and thereafter the print data are transmitted. However, the private printing utility may be activated after the print data are transmitted. In the second processing example, a case where the private printing utility is activated after the print data are transmitted will be described.

First, the operation of the user terminal 3 according to the second processing example will be described.

FIG. 9 is a flowchart illustrating the operation of the user terminal 3 according to the second processing example of private printing.

If a user of the user terminal 3 wants to print an image such as a document being displayed, the user issues a print instruction for that image by operating the operation unit 36. For example, the user issues a print instruction by pressing a print button that is provided by an application for opening an image such as a document to be printed. Upon receiving the print instruction, the CPU 31 of the user terminal 3 activates a printer driver for the digital multifunction peripheral 1 that is installed in the HDD 35 (ACT 51).

If a printer driver for the digital multifunction peripheral 1 is activated, the CPU 31 of the user terminal 3 displays a print setting screen including settings of private printing on the display unit 37. If the user inputs a print execution instruction after making print settings in the print setting screen, the CPU 31 of the user terminal 3 transmits print data including print setting information to the digital multifunction peripheral 1 (ACT 52). If the digital multifunction peripheral 1 having received the print data for private printing is in the sleep state, the user terminal 3 receives a notification from the digital multifunction peripheral 1 indicating that the digital multifunction peripheral 1 is in the sleep state (ACT 53).

Upon receiving the notification indicating that the digital multifunction peripheral 1 is in the sleep state from the digital multifunction peripheral 1, the CPU 31 of the user terminal 3 activates a utility software for private printing (ACT 54). If the private printing utility is activated, the CPU 31 displays a selection window (print-start-time selection window) as a pop-up window on the display unit 37 so as to enable the user to select the time to start actual printing (whether or not to immediately start printing) (ACT 55). The print-start-time selection window may be such a selection window as shown in FIG. 4, for example.

If the user selects the option not to execute private printing immediately in the print-start-time selection window (ACT 56: NO), the CPU 31 of the user terminal 3 transmits a signal that there is no sleep return request to the digital multifunction peripheral 1 (ACT 57). If the user selects the option to execute private printing immediately in the print-start-time selection window (ACT 56: YES), the CPU 31 of the user terminal 3 transmits a sleep return command to the digital multifunction peripheral 1 via the LAN 5 with the aid of the network interface 34, requesting the digital multifunction peripheral 1 to wake up from the sleep state (ACT 58).

The CPU 31 of the user terminal 3 having transmitted the sleep return command receives the status indicating the state of sleep return processing from the digital multifunction peripheral 1 (ACT 59). Upon receiving the status indicating the state of sleep return processing, the CPU 31 of the user terminal 3 displays a guide message corresponding to the acquired status on the display unit 37 (ACT 60). The CPU 31 of the user terminal 3 repeats the operations of ACTS 59 and 60 until the status indicating the completion of the sleep return processing is acquired (ACT 61: NO).

For example, upon receiving the status indicating that the sleep return processing is being executed from the digital multifunction peripheral 1, the CPU 31 of the user terminal 3 displays guide messages “The printing apparatus is waking up” and “Please wait for a while” on the display unit 37 similarly to the example shown in FIG. 5. The guide messages may be displayed on the display unit 37 upon receiving a notification of start of sleep return processing from the digital multifunction peripheral 1 until a notification of completion of the sleep return processing is received.

Upon receiving the status indicating the completion of the sleep return processing from the digital multifunction peripheral 1 (ACT 61: YES), the CPU 31 of the user terminal 3 displays messages on the display unit 37, indicating that the sleep return processing in the digital multifunction peripheral 1 is completed, and that the digital multifunction peripheral 1 is now in a ready state where private printing is executable immediately (ACT 62). For example, the CPU 31 of the user terminal 3 displays messages “Printing apparatus is now ready to print” and “Please execute printing by operating printing apparatus” on the display unit 37 similarly to the example shown in FIG. 6.

Next, the operation of the digital multifunction peripheral 1 according to the second processing example of the private printing will be described.

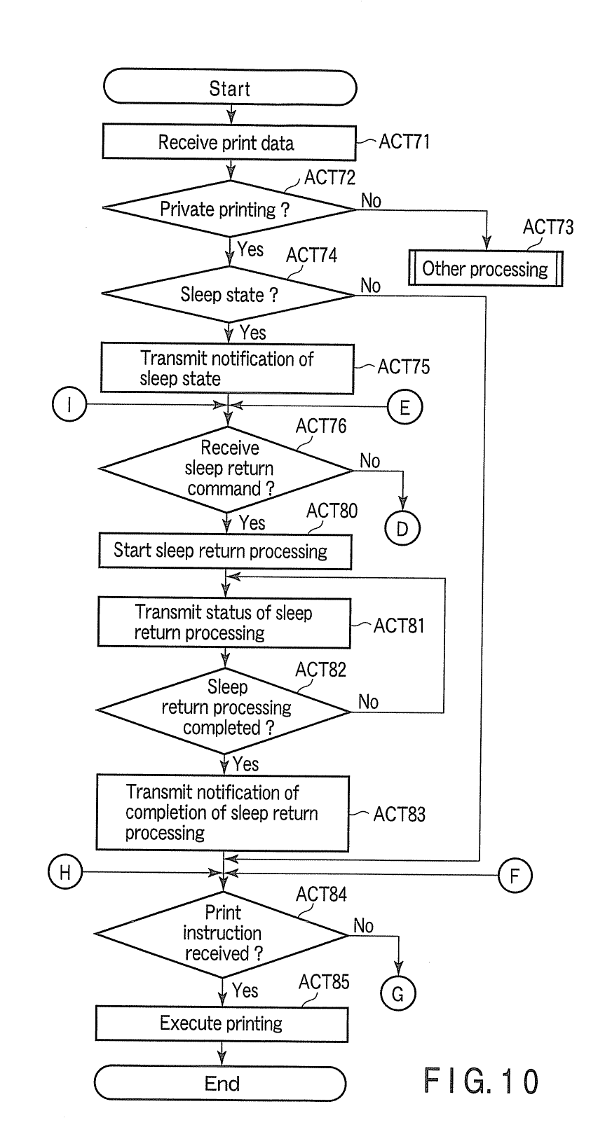

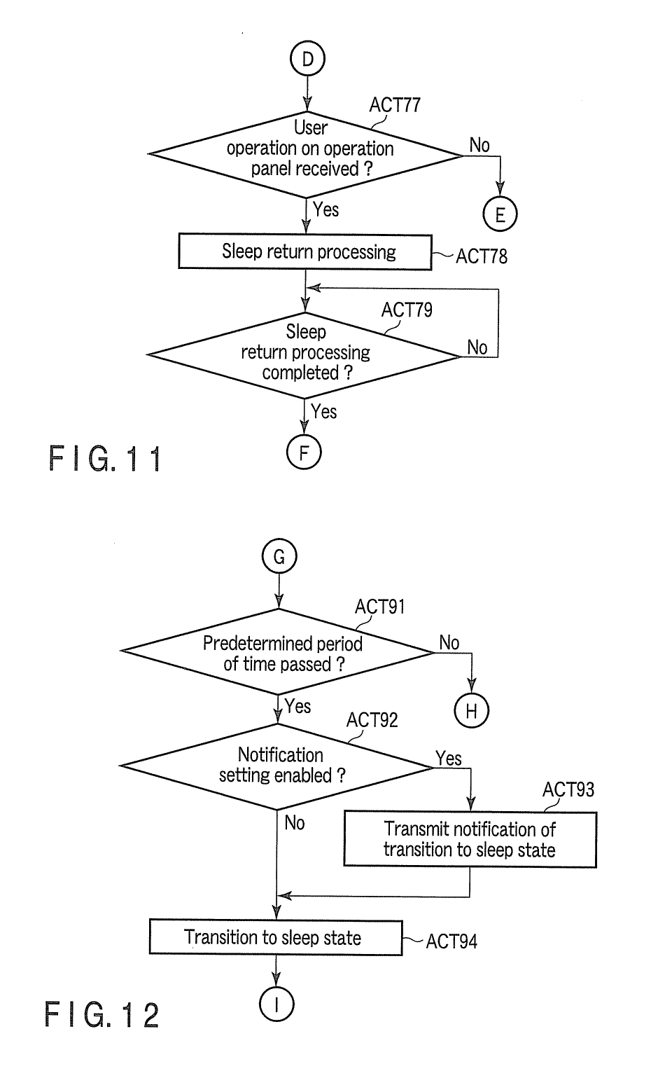

FIGS. 10, 11, and 12 are flowcharts illustrating the operation of the digital multifunction peripheral 1 according to the second processing example of the private printing.

Upon receiving the print data from the user terminal 3 (ACT 71), the CPU 21 of the digital multifunction peripheral 1 stores the print data in the HDD 28 and determines whether or not the print data are designated for private printing based on the print setting information included in the print data (ACT 72). If the received print data are not designated for private printing (ACT 72: NO), the CPU 21 executes processing corresponding to the print settings (ACT 73).

If the received print data are designated for private printing (ACT 72: YES), the CPU 21 determines whether or not the digital multifunction peripheral 1 is in the sleep state (ACT 74). If the digital multifunction peripheral 1 is in the sleep state, the CPU 21 transmits a notification informing that the digital multifunction peripheral 1 is in the sleep state to the user terminal 3 which is the sender of the print data (ACT 75). After transmitting the notification that the digital multifunction peripheral 1 is in the sleep state, the CPU 21 enters a standby state of waiting for a sleep return command from the user terminal 3 (ACT 76).

Moreover, if the user inputs an instruction to the operation panel 17 to perform sleep return processing (ACT 77: YES) before the sleep return command is received from the user terminal 3 (ACT 76: NO), the CPU 21 executes the sleep return processing (ACT 78). If the sleep return processing is executed in response to an operation on the operation panel 17, the CPU 21 may not transmit the status indicating the state of the sleep return processing to the user terminal 3. If the sleep return processing is completed (ACT 79: YES), the CPU 21 enters a standby state of waiting for a print execution instruction input to the operation panel 17 (ACT 84).

Upon receiving the sleep return command from the user terminal 3 (ACT 76: YES), the CPU 21 starts the sleep return processing (ACT 80). If the sleep return processing is started in response to the sleep return command from the user terminal 3, the CPU 21 transmits the status indicating the state of sleep return processing to the user terminal 3 (ACT 81). The CPU 21 transmits the status indicating the state of the sleep return processing to the user terminal 3 until the sleep return processing is completed, namely during the execution of the sleep return processing (ACT 82: NO). For example, the CPU 21 periodically transmits the status indicating the state of the sleep return processing to the user terminal 3 during the execution of the sleep return processing.

If the sleep return processing in response to the sleep return command is completed (ACT 82: YES), the CPU 21 transmits a notification informing the completion of the sleep return processing to the user terminal 3 (alternatively, the entrance of the ready state where printing is possible) (ACT 83). After transmitting the notification of the completion of the sleep return processing to the user terminal 3, the CPU 21 enters a standby state of waiting for a print execution instruction input to the operation panel 17 (ACT 84).

Upon receiving the print execution instruction for the private printing from the user on the operation panel 17 (ACT 84: YES), the CPU 21 of the digital multifunction peripheral 1 reads print data for that private printing from the HDD 38 and executes printing with the printer 13 (ACT 85).

In the state of waiting for a print execution instruction, the CPU 21 determines whether or not the time elapsed from the sleep return exceeds a predetermined period of time, after the lapse of which the sleep state starts again (ACT 91). If the time elapsed from the sleep return exceeds the predetermined period of time (ACT 91: YES), the CPU 21 determines whether or not a setting to send a notification if the digital multifunction peripheral 1 transitions to the sleep state again is enabled (ACT 92). It will be assumed that in the digital multifunction peripheral 1, it is possible to make settings in advance as to whether or not to send a notification if the digital multifunction peripheral 1 transitions to the sleep state again after waking up from the sleep state in response to the sleep return command.

For example, the digital multifunction peripheral 1 is configured to transition to the sleep state if a non-operation state continues for a predetermined period of time or more. For this reason, if the user does not input any instruction to the operation panel 17 of the digital multifunction peripheral 1 for a while (not shorter than the predetermined period of time after the return) after sending the sleep return command from the user terminal 3, the digital multifunction peripheral 1 transitions to the sleep state. In such a case, with the digital multifunction peripheral 1, it is possible to make settings as to whether or not to send a notification if the digital multifunction peripheral 1 transitions to the sleep state again after waking up from the sleep state in response to the sleep return command.

If there is the setting to send a notification if the digital multifunction peripheral 1 transitions to the sleep state again after waking up in response to the sleep return command (ACT 92: YES), the CPU 21 sends a notification to the user terminal 3 to inform that the sleep state starts again (ACT 93) and causes the digital multifunction peripheral 1 to transition to the sleep state (ACT 94).

Upon receiving the notification that the sleep state starts again, the user terminal 3 displays a message that the sleep state is started again and displays a sleep return command using the private printing utility. However, if the notification that the sleep state starts again is received, the user terminal 3 may display the message that the sleep state is started again but may not display the sleep return command using the private printing utility.

If there is no setting to send a notification if the digital multifunction peripheral 1 transitions to the sleep state again (ACT 92: NO), the CPU 21 causes the digital multifunction peripheral 1 to transition to the sleep state (ACT 94) without sending a notification to the user terminal 3 to inform that the sleep state starts again. If the sleep state starts again in ACT 94, the CPU 21 proceeds to ACT 76 and enables reception of a sleep return command from the user terminal 3.

As described above, according to the first and second processing examples, if the user of the user terminal 3 selects the option to execute the private printing immediately, the user terminal 3 sends the sleep return command to the digital multifunction peripheral 1. The digital multifunction peripheral 1 executes the sleep return processing immediately in response to the sleep return command. The digital multifunction peripheral 1 sends a notification of the state of the sleep return processing executed in response to the sleep return command to the user terminal 3. The user terminal 3 displays messages on the display unit 37 until the sleep return processing in the digital multifunction peripheral 1 is completed.

According to the first and second processing examples, even if the digital multifunction peripheral 1 is in the sleep state, the user terminal 3 is able to cause the digital multifunction peripheral 1 to execute the sleep return processing upon receiving a print execution instruction for private printing from the user. As a result, even if the digital multifunction peripheral 1 is in the sleep state, it is possible to reduce the waiting time of the user who, having issued a print execution instruction of private printing at the user terminal 3, then waits for the printing results at the digital multifunction peripheral 1.

Moreover, according to the first and second processing examples, the user is able to recognize at the user terminal 3 that the digital multifunction peripheral 1 is in the ready state where printing is possible. For this reason, the user does not need to wait at the digital multifunction peripheral 1 for the time required for the sleep return processing. That is to say, the user is able to recognize at the user terminal 3 that the digital multifunction peripheral 1 is in the ready state before the user goes to the digital multifunction peripheral 1 and inputs a print execution instruction.

Next, a third processing example of private printing in the image forming system will be described.

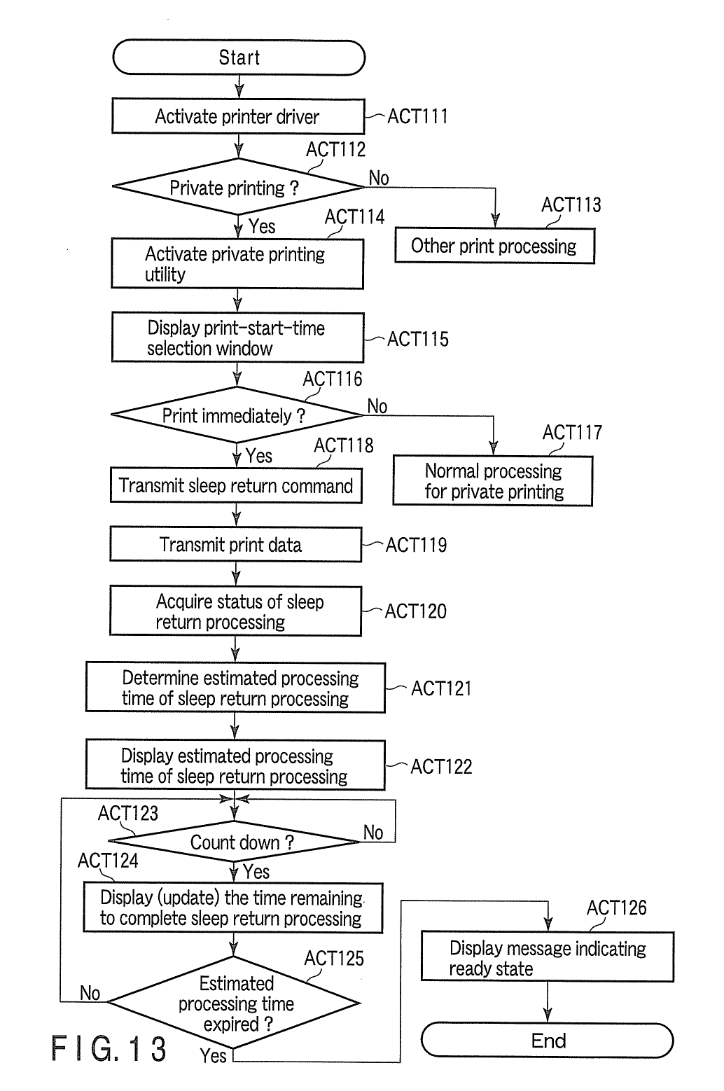

FIG. 13 is a flowchart illustrating the operation of the user terminal 3 according to the third processing example of the private printing.

In the third processing example, the operations (ACTS 111 to 119) of the user terminal 3 before the user selects the time to start the private printing are performed in a manner similar to ACTS 11 to 19 described in the first processing example. For this reason, the operations of ACTS 111 to 119 will be described briefly and detailed description thereof will be omitted.

After activating the printer driver in response to the user's instruction (ACT 111), the CPU 31 of the user terminal 3 displays a print setting screen including settings of private printing on the display unit 37. If private printing is not selected in the print setting screen (ACT 112: NO), the CPU 31 of the user terminal 3 sends a normal print request other than a private print request to the digital multifunction peripheral 1 (ACT 113). If private printing is selected in the print setting screen (ACT 112: YES), the CPU 31 of the user terminal 3 activates a utility software for private printing (ACT 114). If the private printing utility is activated, the CPU 31 displays a print-start-time selection window as shown in FIG. 4 on the display unit 37 (ACT 115).

If the user selects the option to execute private printing immediately in the print-start-time selection window (ACT 116: YES), the CPU 31 of the user terminal 3 transmits a sleep return command to the digital multifunction peripheral 1 via the LAN 5 with the aid of the network interface 34 (ACT 118), and transmits print data for private printing (ACT 119). The user terminal 3 having transmitted the sleep return command and the print data receives information for determining the time (estimated processing time of the sleep return) necessary for the sleep return processing from the digital multifunction peripheral 1 with the aid of the network interface 34 (ACT 120).

Upon receiving the information for determining the estimated processing time of the sleep return from the digital multifunction peripheral 1, the CPU 31 of the user terminal 3 determines the estimated processing time of the sleep return based on the received information (ACT 121). As a method of determining the estimated processing time of the sleep return, there may be considered a method of calculating the time by the user terminal 3, a method of determining the time from a fixed value by the user terminal 3, a method of calculating the time by the digital multifunction peripheral 1, or a method of determining the time from a fixed value by the digital multifunction peripheral 1.

If the user terminal 3 calculates the estimated processing time of the sleep return, the CPU 31 of the user terminal 3 calculates the estimated processing time of the sleep return processing based on the information received from the digital multifunction peripheral 1. The process of calculating the estimated processing time of the sleep return processing is implemented by the CPU 31 executing the application (utility) installed in the HDD 35. For example, the CPU 31 of the user terminal 3 acquires temperature inside the fixing unit of the printer 13 from the digital multifunction peripheral 1 and calculates the estimated processing time of the sleep return processing from the acquired temperature inside the fixing unit.

Moreover, the estimated processing time of the sleep return may be determined from a fixed value that the CPU 31 of the user terminal 3 stores in advance in a memory such as the HDD 35. For example, the HDD 35 may have stored therein a plurality of estimated processing times of sleep return which are correlated to the temperatures of the fixing unit of the printer 13. In this case, the CPU 31 determines the estimated processing time of the sleep return corresponding to the temperature information of the fixing unit acquired from the digital multifunction peripheral 1 from the plurality of estimated processing times stored in the HDD 35.

Furthermore, the estimated processing time of the sleep return may be calculated by the digital multifunction peripheral 1. For example, by installing an application (utility) for calculating the estimated processing time of the sleep return in the HDD 35, the system control unit 20 of the digital multifunction peripheral 1 is able to calculate the estimated processing time of the sleep return with the aid of the CPU 21. If the estimated processing time of the sleep return is calculated by the digital multifunction peripheral 1, the CPU 31 of the user terminal 3 may receive the estimated processing time of the sleep return from the digital multifunction peripheral 1 in ACT 21. In addition, the operation of determining the estimated processing time from the plurality of estimated processing times stored in the memory in advance may be executed by the digital multifunction peripheral 1.

If the estimated processing time of the sleep return in the digital multifunction peripheral 1 is determined, the CPU 31 displays the estimated processing time of the sleep return in the guide message indicating the state of the sleep return on the display unit 37 (ACT 122). Here, the estimated processing time of the sleep return displayed on the display unit 37 is the time remaining to complete the sleep return.

If the estimated processing time of the sleep return is displayed, the CPU 31 counts down every unit time (e.g., 1 second) displayed by the timer 38. That is to say, whenever the unit time (1 second) being displayed is passed (ACT 123: YES), the CPU 31 counts down the time displayed on the display unit 37, thereby updating and displaying the time remaining to complete the sleep return processing (ACT 124).

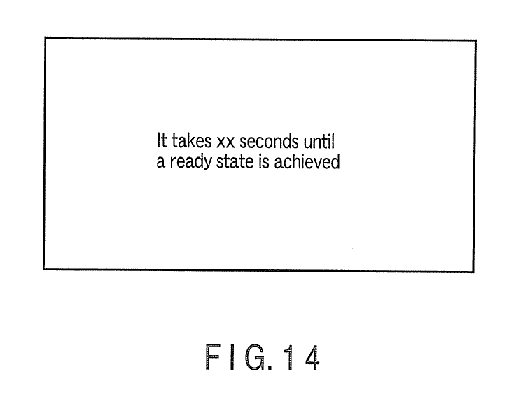

FIG. 14 illustrates an example of a guide message that gives information on the estimated processing time of the sleep return, namely the time remaining to complete the sleep return.

In the example shown in FIG. 14, the display unit 37 displays a message “It takes XX seconds until a ready state is achieved”. Here, “XX seconds” represent the time remaining to complete the sleep return processing. The CPU 31 updates the “XX seconds” part in the guide message shown in FIG. 14. That is to say, the CPU 31 updates the value “XX” (the remaining time) to the value being counted down with the progress of the time counted by the timer 38. Moreover, the CPU 31 of the user terminal 3 may display the guide message shown in FIG. 14 on the display unit 37 as a pop-up window.

The control of displays of the guide message indicating the time remaining to complete the sleep return processing is implemented by the CPU 31 executing an application (utility). For this reason, by updating the application, the contents displayed on the display unit 37 as a message informing the completion of print preparation can be configured easily.

The CPU 31 of the user terminal 3 updates the time remaining to complete the sleep return being displayed on the display unit 37 until the time remaining to complete the sleep return becomes “0”. As a result, the time (estimated processing time) remaining to complete the sleep return processing is displayed on the display unit 37 until the estimated processing time of the sleep return is passed. Therefore, the user having issued the print execution instruction for private printing is able to constantly monitor the time remaining to complete the sleep return processing being displayed on the display unit 37 of the user terminal 3.

When the time remaining to complete the sleep return processing becomes “0”, namely if the time being counted down becomes “0” (ACT 125: YES), the CPU 31 displays a guide message indicating that the digital multifunction peripheral 1 is in the ready state where printing is possible on the display unit 37 (ACT 126). The guide message may have the same contents as those shown in FIG. 6, for example.

If the message indicating that the digital multifunction peripheral 1 is in the ready state where printing is possible is displayed on the display unit 37, the digital multifunction peripheral 1 has completed the sleep return processing (more specifically, the estimated processing time of the sleep return has elapsed). Therefore, upon seeing the message displayed on the display unit 37 indicating the ready state, the user moves to an installation site of the digital multifunction peripheral 1 and inputs a print execution instruction to the operation panel 17 of the digital multifunction peripheral 1. Then, the digital multifunction peripheral 1 immediately executes private printing with the aid of the printer 13. As a result, the user is able to recognize the completion of the sleep return processing at the user terminal 3 without having to wait for completion of the sleep return processing in the vicinity of the digital multifunction peripheral 1.

Next, the operation of the digital multifunction peripheral 1 according to the third processing example of the private printing will be described.

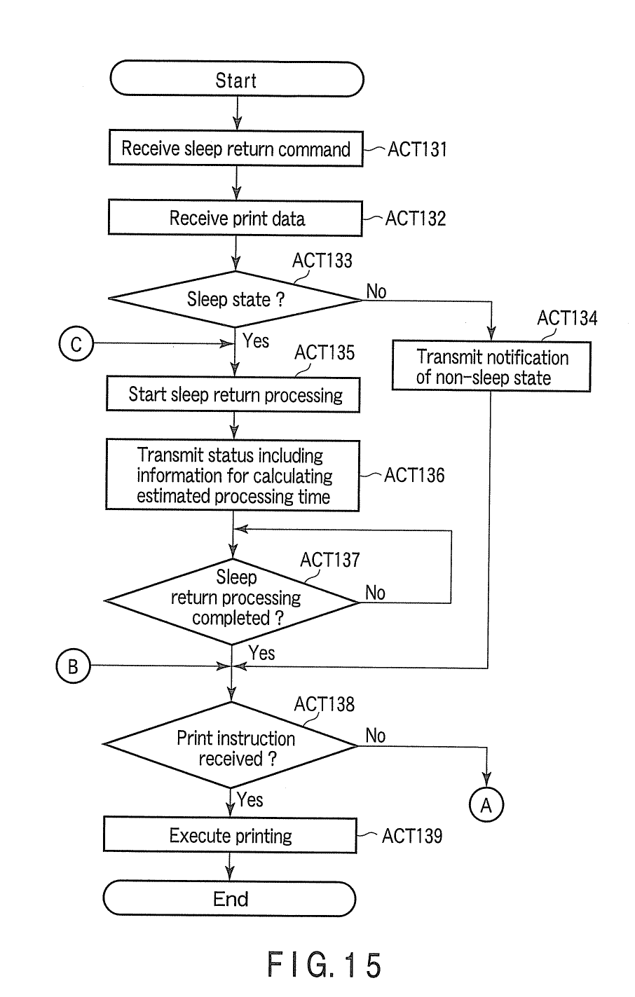

FIG. 15 is a flowchart illustrating the operation of the digital multifunction peripheral 1 according to the third processing example of the private printing.

In the third processing example, the operations (ACTS 131 to 135) of the digital multifunction peripheral 1 before the sleep return processing is started in response to the sleep return command are performed in a manner similar to ACTS 31 to 35 described in the first processing example. Moreover, in the third processing example, the operations (ACTS 138 and 139 and the ACTS shown in FIG. 8) of the digital multifunction peripheral 1 after the sleep return processing is completed are performed in a manner similar to ACTS 39 and 40 described in the first processing example and the ACTS shown in FIG. 8. For this reason, the operations of ACTS 131 to 139 and subsequent operations of ACT 139 will be described briefly and detailed description thereof will be omitted.

First, the digital multifunction peripheral 1 receives a sleep return command from the user terminal 3 and print data for private printing with the aid of the network interface 25 (ACTS 131 and 132). If the digital multifunction peripheral 1 is not in the sleep state (ACT 133: NO), the CPU 21 sends a notification to the user terminal 3, informing that the digital multifunction peripheral 1 is not in the sleep state (alternatively, the digital multifunction peripheral 1 is in a ready state where printing is possible) (ACT 134). If the digital multifunction peripheral 1 is in the sleep state (ACT 133: YES), the CPU 21 starts sleep return processing such as warm-up in the printer 13 (ACT 135).

If the sleep return processing is started in response to the sleep return command, the CPU 21 of the digital multifunction peripheral 1 transmits the status indicating the start of the sleep return processing and information for calculating the time (estimated processing time) necessary for the sleep return processing to the user terminal 3 (ACT 136). For example, the CPU 21 transmits temperature inside the fixing unit of the printer 13 to the user terminal 3 as the information for calculating the estimated processing time of the sleep return. The estimated processing time of the sleep return may be calculated by the CPU 21. In this case, the CPU 21 transmits the calculated estimated processing time of the sleep return to the user terminal 3 in ACT 136.

Upon completion of the sleep return processing performed in response to the sleep return command received together with the print data (ACT 137: YES), the CPU 21 of the digital multifunction peripheral 1 enters a ready state where printing is executable immediately. The digital multifunction peripheral 1 being in the ready state where printing is executable immediately waits until the user inputs a print execution instruction of the private printing on the operation panel 17 (ACT 138).

If the user inputs a print execution instruction for the private printing on the operation panel 17 (ACT 138: YES), the CPU 21 of the digital multifunction peripheral 1 executes private printing with the printer 13 (ACT 139).

In the state of waiting for a print execution instruction, the CPU 21 determines whether or not the time elapsed from the sleep return exceeds a predetermined period of time, after the lapse of which the sleep state starts again (ACT 41). If the time elapsed from the sleep return exceeds the predetermined period of time (ACT 41: YES) and the setting to send a notification of another sleep state is enabled (ACT 42: YES), the CPU 21 sends a notification to the user terminal 3 to inform that the sleep state starts again (ACT 43) and causes the digital multifunction peripheral 1 to transition to the sleep state (ACT 44). If the setting to send a notification of another sleep state is not enabled (ACT 42: NO), the CPU 21 causes the digital multifunction peripheral 1 to transition to the sleep state (ACT 44) without sending the notification of another sleep state. If the sleep state starts again in ACT 44, the CPU 21 enables reception of a sleep return command from the user terminal 3 (ACT 45).

Upon receiving the sleep return command from the user terminal 3 after the sleep state is started again (ACT 45: YES), the CPU 21 proceeds to ACT 36 and starts the sleep return processing to execute the operations starting from ACT 36 again. Moreover, if the user inputs an instruction to the operation panel 17 to perform sleep return processing (ACT 46: YES) after the sleep state is started again before the sleep return command is received (ACT 45: NO), the CPU 21 executes the sleep return processing (ACT 47). If the sleep return processing is completed (ACT 48: YES), the CPU 21 enters a standby state of waiting for a print execution instruction (ACT 139).

As described above, according to the third processing example, if the user of the user terminal 3 selects the option to execute the private printing immediately, the user terminal 3 sends the sleep return command to the digital multifunction peripheral 1. The digital multifunction peripheral 1 executes the sleep return processing immediately in response to the sleep return command and notify the user terminal 3 of the information for determining the estimated processing time of the sleep return. The user terminal 3 determines the estimated processing time of the sleep return based on the information acquired from the digital multifunction peripheral 1. The user terminal 3 displays a guide message indicating the time remaining to complete the sleep return to the display unit 37 based on the estimated processing time of the sleep return.

According to the third processing example, even if the digital multifunction peripheral 1 is in the sleep state, the user terminal 3 is able to cause the digital multifunction peripheral 1 to execute the sleep return processing upon receiving a print execution instruction for private printing from the user. As a result, even if the digital multifunction peripheral 1 is in the sleep state, it is possible to reduce the waiting time of the user who, having issued a print execution instruction of private printing at the user terminal 3, then waits for the printing results at the digital multifunction peripheral 1.

Moreover, according to the third processing example, the user is able to recognize at the user terminal 3 that the digital multifunction peripheral 1 is under the sleep return processing and monitor the time remaining to the complete the sleep return processing on the display unit 37 of the user terminal 3. For this reason, the user does not need to wait at the digital multifunction peripheral for the time required for the sleep return processing. Moreover, the user is able to recognize at the user terminal 3 that the digital multifunction peripheral 1 is in the ready state before the user goes to the digital multifunction peripheral 1 and inputs a print execution instruction.

Furthermore, according to the third processing example, the digital multifunction peripheral 1 does not need to constantly or periodically notify the user terminal 3 of the state of the sleep return during the execution of the sleep return processing. That is to say, by receiving only the information for determining the estimated processing time of the sleep return from the digital multifunction peripheral 1 in response to the sleep return command, the user terminal 3 is able to inform the user of the time remaining to complete the sleep return processing, namely the time remaining until actual printing is made possible.

As described above, in the image forming system of this embodiment, if the private printing function is selected, the user terminal 3 displays an operation guide message on the display unit so as to enable the user to select whether or not to start printing immediately. If the user selects the option to execute the printing immediately, the user terminal 3 issues the sleep return command requesting the digital multifunction peripheral 1 to start the sleep return processing. The digital multifunction peripheral 1 starts the sleep return processing in response to the sleep return command. In addition, the user terminal 3 has a function of displaying a message indicating the completion of the sleep return, namely the completion of print preparation, or a function of displaying the time remaining to complete the sleep return. In the image forming system, it is possible to reduce the waiting time of the user if the user waits at the digital multifunction peripheral 1 until printing is started.

In the image forming system, the user terminal 3 may be configured to send a request for sleep return processing at any time to the digital multifunction peripheral 1. That is to say, the user terminal 3 may have installed therein a utility capable of issuing a sleep return command at any time in response to a user's instruction. With the utility capable of issuing the sleep return command at any time, the user terminal 3 is able to cause the digital multifunction peripheral 1 to perform sleep return processing at any time in response to the user's instruction without being limited to the time if the private printing is selected.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for controlling an image forming apparatus at a terminal device, comprising:
displaying a selection message to select whether or not to immediately execute private printing which is executed if an operation unit of the image forming apparatus is operated; and
transmitting a sleep return command to the image forming apparatus to wake up the image forming apparatus from a sleep state if the private printing is selected to be executed immediately.

2. The method according to claim 1, wherein the displaying a selection message includes displaying a selection message to select whether or not to immediately execute the private printing if setting of the private printing is made.

3. The method according to claim 1, further comprising transmitting print data of the private printing,
wherein the displaying a selection message includes displaying a selection message to select whether or not to immediately execute the private printing upon receiving a notification of a sleep state from the image forming apparatus after the print data are transmitted.

4. The method according to claim 1, further comprising:
receiving a status indicating state of sleep return processing which the image forming apparatus executes in response to the sleep return command; and
displaying a guide message indicating the state of the sleep return processing in the image forming apparatus in accordance with the received status.

5. The method according to claim 4, wherein the displaying a message indicating the state of the sleep return processing includes displaying a message indicating completion of the sleep return processing in accordance with a status indicating completion of the sleep return processing.

6. The method according to claim 1, further comprising:
calculating estimated processing time of sleep return processing in the image forming apparatus based on information included in the status received from the image forming apparatus; and
displaying the calculated estimated processing time of the sleep return processing in the image forming apparatus.

7. The method according to claim 6, further comprising:
counting down the calculated estimated processing time of the sleep return processing; and
displaying the time being counted down as the time remaining to complete the sleep return processing.

8. The method according to claim 1, further comprising:
receiving, from the image forming apparatus, estimated processing time of sleep return processing which the image forming apparatus executes in response to the sleep return command; and
displaying the estimated processing time of the sleep return command received from the image forming apparatus.

9. The method according to claim 1, further comprising:
storing estimated processing time of sleep return processing in a memory to be correlated to information that can be acquired from the image forming apparatus as a status; and
determining the estimated processing time of the sleep return processing based on the information acquired from the image forming apparatus as the status and information stored in the memory,
wherein the status is information for determining the estimated processing time of the sleep return processing, and the guide message indicating the state of the sleep return processing is a message indicating the determined estimated processing time of the sleep return processing.

10. An image forming system comprising:
a terminal device comprises:
a selection display unit that displays a selection message to select whether or not to immediately execute private printing which is executed if an operation unit of the image forming apparatus is operated, and
a command transmitting unit that transmits a sleep return command to the image forming apparatus to wake up the image forming apparatus from a sleep state if the private printing is selected to be executed immediately, and
an image forming apparatus comprises:
a command receiving unit that receives the sleep return command from the terminal device, and
a return processing unit that executes sleep return processing to achieve a state where image formation is possible if the command receiving unit receives the sleep return command.

11. The system according to claim 10, wherein the selection display unit of the terminal device displays a selection message to select whether or not to immediately execute the private printing if setting of the private printing is made.

12. The system according to claim 10, wherein:
the terminal device further comprises a data receiving unit that transmits print data of the private printing to the image forming apparatus, and
the selection display unit displays a selection message to select whether or not to immediately execute the private printing upon receiving a notification of a sleep state from the image forming apparatus after the print data are transmitted.

13. The system according to claim 10, wherein:
the terminal device further comprises:
a status receiving unit that receives, from the image forming apparatus, a status indicating the state of the sleep return processing which the image forming apparatus executes in response to the sleep return command; and
a message display unit that displays a guide message indicating the state of the sleep return processing in the image forming apparatus in accordance with the status received by the status receiving unit, and
the image forming apparatus further comprises:
a status transmitting unit that transmits, to the terminal device, a status indicating the state of the sleep return processing executed by the return processing unit.

14. The system according to claim 13, wherein the message display unit of the terminal device displays a guide message indicating the completion of the sleep return processing if the status receiving unit receives the status indicating the completion of the sleep return processing.

15. The system according to claim 13, wherein:
the terminal device further comprises a calculation unit that calculates estimated processing time of the sleep return processing in the image forming apparatus based on information included in the status that the status receiving unit receives from the image forming apparatus; and
the message display unit displays the estimated processing time of the sleep return processing in the image forming apparatus, calculated by the calculation unit.

16. The system according to claim 15, wherein:
the terminal device further comprises a timer that counts down the calculated estimated processing time of the sleep return processing, and
the message display unit displays the time being counted down by the timer as the time remaining to complete the sleep return processing.

17. The system according to claim 10, wherein:
the terminal device further comprises an estimated time-receiving unit that receives, from the image forming apparatus, estimated processing time of the sleep return processing which the image forming apparatus executes in response to the sleep return command,
the message display unit displays the estimated processing time of the sleep return processing received from the image forming apparatus,
the image forming apparatus further comprises a calculation unit that calculates the estimated processing time of the sleep return processing if the command receiving unit receives the sleep return command, and
the status transmitting unit transmits a status including the estimated processing time of the sleep return processing calculated by the calculation unit.

18. The system according to claim 10, wherein:
the terminal device further comprises:
a memory that stores estimated processing time of sleep return processing to be correlated to information that can be acquired from the image forming apparatus as a status; and
a determination unit that determines the estimated processing time of the sleep return processing based on the information acquired from the image forming apparatus as the status and information stored in the memory, and
the message display unit displays the estimated processing time of the sleep return processing determined by the determination unit.

19. A computer-readable memory containing program instructions for:
displaying a selection message to select whether or not to immediately execute private printing which is executed if an operation unit of the image forming apparatus is operated; and
transmitting a sleep return command to the image forming apparatus to wake up the image forming apparatus from a sleep state if the private printing is selected to be executed immediately.

20. The memory according to claim 19, further containing program instructions for:
receiving a status indicating the state of sleep return processing which the image forming apparatus executes in response to the sleep return command; and
displaying a guide message indicating the state of the sleep return processing in the image forming apparatus in accordance with the received status.
